(19) United States
(12) Patent Application Publication
(10) Pub. No.: US 2005/0002332 A1
(43) Pub. Date: Jan. 6, 2005

(54) Method, apparatus and computer program for performing a frame flow control, and method, apparatus and computer program for transmitting a frame

(76) Inventor: Hwa-Seok Oh, Seoul (KR)

Correspondence Address: HARNESS, DICKEY & PIERCE, P.L.C., P.O. BOX 8910, RESTON, VA, 20195, US

(21) Appl. No.: 10/861,493

(22) Filed: Jun. 7, 2004

(30) Foreign Application Priority Data
Jul. 1, 2003 (KR) 2003-44406

(51) Int. Cl. H04L 12/26

(52) U.S. Cl. 370/229

(57) ABSTRACT

A method, apparatus and computer program for performing a frame flow control, in which a comparator may count a length of a first data frame received from a first port and compare the length to a bandwidth limit value. The apparatus may include a pause frame unit which may determine a delay time based on the comparison of the comparator, and which may generate a pause frame with the bandwidth limit value based on the delay time. A frame transmitter may be configured to transmit the pause frame to the first port. A method, apparatus and computer program for transmitting a frame may receive a pause frame having a delay time from a port and calculate an idle time based on the delay time. A frame transmitter may transmit a first data frame to the port so that transmission of the first data frame is delayed by the idle time.

### PRIORITY STATEMENT

This non-provisional application claims priority under 35 U.S.C. §119(a)-(d) to Korean Patent Application No. 2003-44406 filed on Jul. 1, 2003 in the Korean intellectual property Office (KIPO), the entire contents of which are hereby incorporated by reference.

### BACKGROUND OF THE INVENTION

1. Field of the Invention

The present invention, in general, relates to a method and apparatus for performing frame flow control, and to a method and an apparatus for transmitting a frame.

2. Description of the Related Art

In a conventional frame flow control device such as an Ethernet switch, if bandwidth of a specific port is limited to a given bandwidth limit value and a frame is received, the conventional frame flow control device accepts only a frame having a length that is less than the bandwidth limit value. In this case, the conventional frame flow control device discards a frame having a length greater than the bandwidth limit value, or requests that a remote terminal, such as a Network Interface Card (NIC) of a user Personnel Computer (PC), for example, to transmit a reduced amount of frames.

However, when a large amount of frames are received abruptly in a port of the conventional frame flow control device, these received frames are stacked at the port of the conventional frame flow control device. Thus, the conventional frame flow control device has to continuously perform flow control.

### SUMMARY OF THE INVENTION

An exemplary embodiment of the present invention is directed to an apparatus for performing a frame flow control. The apparatus may include a comparator configured to count a length of a first data frame received from a first port, and configured to compare the length to a bandwidth limit value. The apparatus may include a pause frame unit configured to determine a delay time based on the comparison of the comparator, and configured to generate a pause frame with the bandwidth limit value based on the delay time. The apparatus may also include a frame transmitter configured to transmit the pause frame to the first port.

Another exemplary embodiment of the present invention is directed to a reserved field of a frame structure of a pause frame. The reserved field may include a first control word in which a delay-time identifier is recorded, the delay-time identifier representing whether or not a delay time is recorded in the pause frame. The reserved field may include a second control word in which the delay time is recorded.

Another exemplary embodiment of the present invention is directed to an apparatus for transmitting a frame. The apparatus may include a pause frame receiver configured to receive a pause frame from a port, the pause frame having a delay time, and a pause frame unit configured to calculate an idle time based on the delay time. The apparatus may also include a frame transmitter configured to transmit a first data frame to the port so that transmission of the first data frame is delayed by the idle time.

Another exemplary embodiment of the present invention is directed to method of performing a frame flow control, in which a length of a received first data frame is counted and compared to a bandwidth limit value. A delay time may be determined based on the comparison; and a pause frame including the bandwidth limit value may be generated based on the delay time for transmission.

Another exemplary embodiment of the present invention is directed to method of transmitting a frame, in which a received pause frame having a delay time may be identified and an idle time may be determined based on the delay time. A first data frame may be transmitted to a given port so that transmission of the first data frame is delayed by the idle time, and the pause frame may be transmitted to the given port.

Another exemplary embodiment of the present invention is directed to a computer program product. The computer program product may include a computer-readable medium having computer program logic stored thereon for enabling a processor to perform a frame flow control. The computer program logic may cause the processor to count a length of a received first data frame and compare the counted length to a bandwidth limit value The computer program logic may cause the processor to determine a delay time based on the comparison, generate a pause frame including the bandwidth limit value based on the delay time, and to transmit the pause frame.

Another exemplary embodiment of the present invention is directed to a computer program product. The computer program product may include a computer-readable medium having computer program logic stored thereon for enabling a processor to transmit a frame. The computer program logic may cause the processor to receive a pause frame having a delay time so as to identify the pause frame, to determine an idle time based on the delay time, and to transmit a first data frame to a given port so that transmission of the first data frame is delayed by the idle time. The computer program logic may cause the processor to transmit the pause frame to the given port.

Another exemplary embodiment of the present invention is directed to a computer data signal embodied in a carrier wave. The computer data signal may be adapted for performing a frame flow control. The computer data signal may include instructions for counting a length of a received first data frame, for comparing the length to a bandwidth limit value, and for determining a delay time based on the comparison. The computer data signal may also include instructions for generating a pause frame including the bandwidth limit value based on the delay time, and for transmitting the pause frame.

Another exemplary embodiment of the present invention is directed to a computer data signal embodied in a carrier wave. The computer data signal may be adapted for transmitting a frame. The computer data signal may include instructions for receiving a pause frame having a delay time, for identifying the pause frame, and for determining an idle time based on the delay time. The computer data signal may also include instructions for transmitting a first data frame to a given port so that transmission of the first data frame is delayed by the idle time, and for transmitting the pause frame to the given port.

### BRIEF DESCRIPTION OF THE DRAWINGS

The present invention will become more apparent by describing, in detail, exemplary embodiments thereof with reference to the attached drawings, wherein like elements are represented by like reference numerals, which are given by way of illustration only and thus do not limit the exemplary embodiments of the present invention.

FIG. 1 is a schematic block diagram showing a frame flow control apparatus according to an exemplary embodiment of the present invention.

FIG. 2 is a schematic block diagram showing a frame receiver of FIG. 1 according to an exemplary embodiment of the present invention.

FIG. 3 is a schematic block diagram showing a comparator of FIG. 1 according to an exemplary embodiment of the present invention.

FIG. 4A is a schematic block diagram showing a pause frame unit of FIG. 1 according to an exemplary embodiment of the present invention.

FIG. 4B is a schematic block diagram showing a frame structure of a pause frame according to an exemplary embodiment of the present invention.

FIG. 5 is a schematic block diagram showing a frame transmitter of FIG. 1 according to an exemplary embodiment of the present invention.

FIG. 6 is a schematic block diagram showing a frame transmitting apparatus according to another exemplary embodiment of the present invention.

FIG. 7 is a schematic block diagram showing a pause frame unit of FIG. 6 according to another exemplary embodiment of the present invention.

FIG. 8 is a schematic block diagram showing a frame transmitter of FIG. 6 according to another exemplary embodiment of the present invention.

FIG. 9 is a flow chart illustrating a frame flow control method according to an exemplary embodiment of the present invention.

FIG. 10 is a flow chart illustrating a method of transmitting a pause frame according to an exemplary embodiment of the present invention.

FIG. 11 is a flow chart illustrating a method of transmitting a frame according to an exemplary embodiment of the present invention.

FIG. 12 is a flow chart illustrating a method of transmitting a frame according to another exemplary embodiment of the present invention.

FIG. 13 is a flow chart illustrating a frame flow control method and a method of transmitting a frame according to an exemplary embodiment of the present invention.

### DETAILED DESCRIPTION OF THE EXEMPLARY EMBODIMENTS

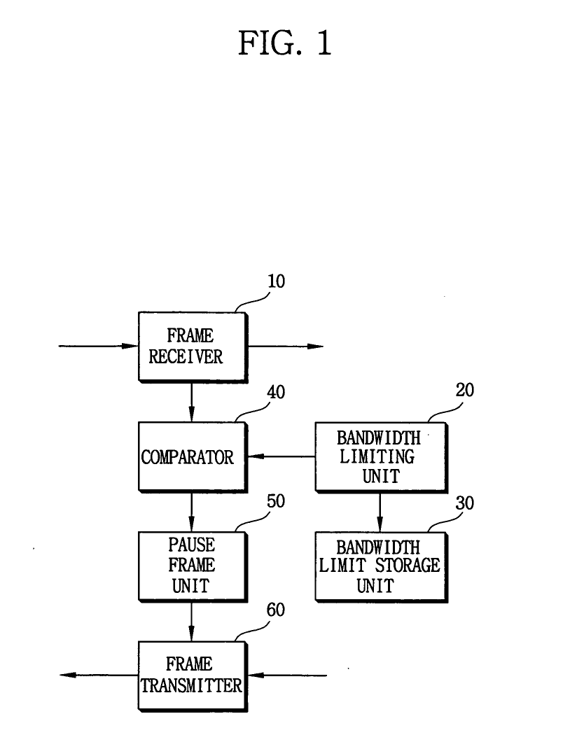

FIG. 1 is a schematic block diagram showing a frame flow control apparatus according to an exemplary embodiment of the present invention. The frame flow control apparatus may be embodied as an Ethernet switch, for example. In FIG. 1, the frame flow control apparatus may include a frame receiver 10 that receives a first data frame and a pause frame from a first port (not shown) of a remote terminal. For example, the remote terminal may be a Network Interface Card (NIC) of a user Personnel Computer (PC). The first data frame may represent a data frame that is transmitted from the first port of the remote terminal to a second port (not shown) of the frame flow control apparatus. The pause frame will be illustrated in further detail below.

The frame flow control apparatus may include a bandwidth limiting unit 20 which may be configured to restrict a bandwidth of a given port in the frame flow control apparatus. For example, in a 100 Mbps Ethernet switch, the bandwidth of the given port in the frame flow control apparatus may be restricted to 10 Mbps. Thus, a data frame having a bandwidth less than 10 Mbps may be received/transmitted via the given port.

The frame flow control apparatus may include a bandwidth limit storage unit 30 which stores a bandwidth limit value of the given port. Bandwidth storage unit 30 may be embodied by a suitable rewriteable memory such as RAM, ROM, flash memory, hard disk, etc.

The frame flow control apparatus may also include a comparator 40. The comparator 40 may be configured to count a length of the first data frame provided from the first port, and to compare the count result with the bandwidth limit value. If the length of the first data frame is greater than the bandwidth limit value, the frame flow control apparatus may perform a frame flow control as to be described in further detail hereinbelow.

The frame flow control apparatus may include a frame pause unit 50. The pause frame unit 50 may calculate a delay time per M-byte frame based on the bandwidth limit value, if the length of the first data frame is greater than the bandwidth limit value. The pause frame unit 50 may generate a pause frame at the bandwidth limit value, based on the calculated delay time. For example, M may be an integer greater than or equal to 64.

The frame flow control apparatus may include a frame transmitter 60 which may be configured to provide the pause frame to the first port. For example, the frame transmitter 60 may transmit the pause frame and a second data frame to the first port of the remote terminal. The second frame may represent a data frame that is transmitted to the first port from a port different from the first port, for example.

Since the frame flow control apparatus transmits the pause frame with information indicating the delay time (corresponding to the bandwidth limit value) to the first port of the remote terminal, the remote terminal has the information indicating the bandwidth limit value. Thus, the remote terminal may transmit the first data frame to the frame flow control apparatus based on the bandwidth limit value. Accordingly, the amount of frame loss may be reduced and frame flow control may be performed in a substantially stable manner.

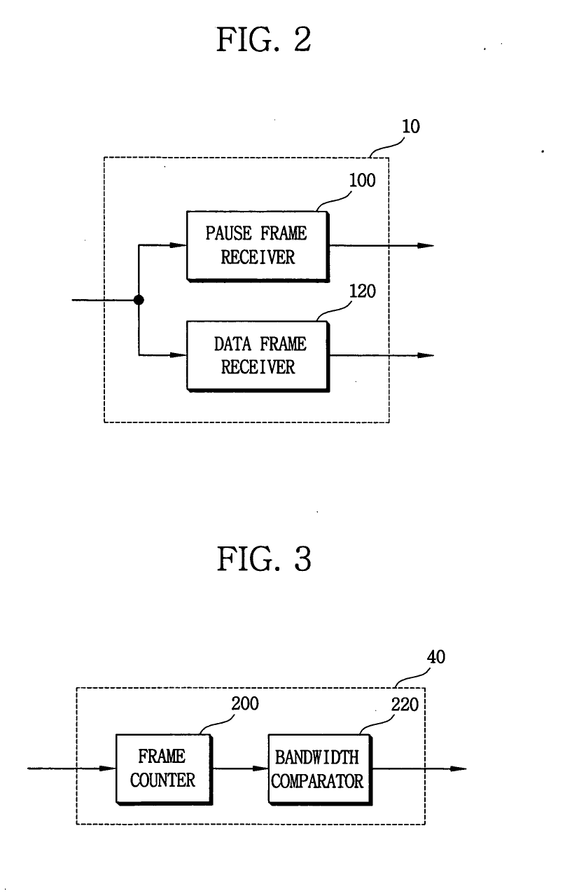

FIG. 2 is a schematic block diagram showing a frame receiver of FIG. 1 according to an exemplary embodiment of the present invention. As shown in FIG. 2, the frame receiver 10 may include a pause frame receiver 100. The pause frame receiver 100 may be configured to receive a pause frame from the first port of the remote terminal. The pause frame is the same pause frame that is transmitted from the second port of the frame flow control apparatus to the first port of the remote terminal. The frame receiver 10 may include a data frame receiver 120. The data frame receiver 120 may be configured to receive the first data frame from the first port of the frame flow control apparatus.

FIG. 3 is a schematic block diagram showing a comparator of FIG. 1 according to an exemplary embodiment of the present invention. Referring to FIG. 3, the comparator 40 may include a frame counter 200 and a bandwidth comparator 220. The frame counter 200 may be configured to count the length (in bits/sec) of the first data frame. The bandwidth comparator 220 may be configured to compare the length of the first data frame with the bandwidth limit value. For example, the bandwidth comparator 220 checks whether the length of the first data frame received from the first port exceeds the bandwidth limit value.

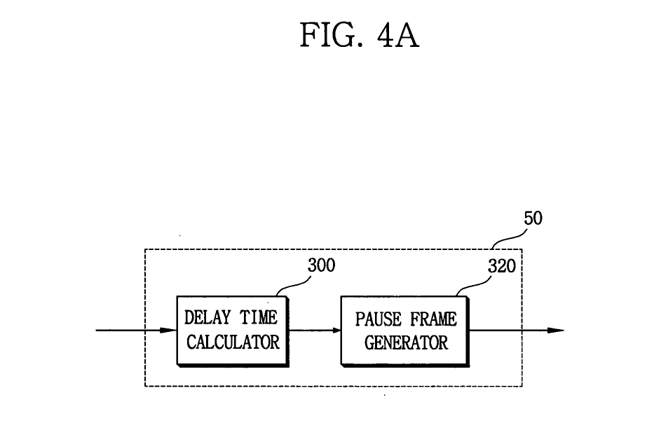

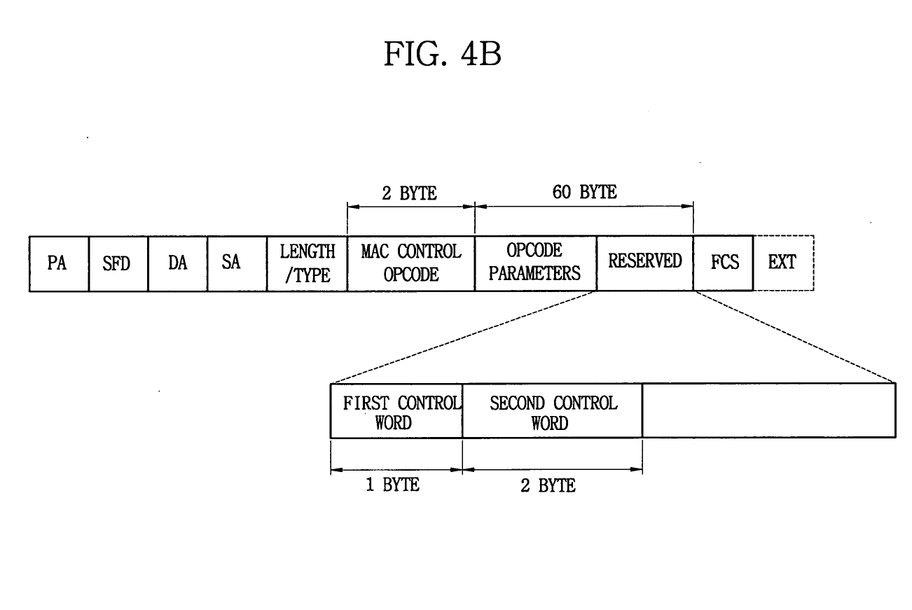

FIG. 4A is a schematic block diagram showing a pause frame unit of FIG. 1 according to an exemplary embodiment of the present invention. As shown in FIG. 4A, the pause frame unit 50 may include a delay time calculator 300 and a pause frame generator 320. The delay time calculator 300 may be configured to calculate the delay time based on the bandwidth limit value. For example, if the bandwidth limit value of the second port is 10 Mbps in a 100 Mbps Ethernet switch, and M is 64, since the second port is able to accept only 10% (10 Mbps) of the maximum bandwidth (100 Mbps) of the communication link due to the bandwidth limit, the delay time corresponds to 64×10 bytes. In the case where the remote terminal transmits a 64-byte frame to the second port of the frame flow control apparatus, 64×10 bytes of the delay time represents that the next 64-byte frame is transmitted to the second port after the first 64-byte frame has been transmitted to the second port and a time period (hereinafter is referred to as “idle time”) corresponding to a 9×64 -byte frame has passed. Thus, when the bandwidth of a given port has been restricted to a given bandwidth limit value, the transmission of the frame is delayed by the delay time, with the delay time calculated based on the bandwidth limit value and the length of the frame.

Thus, when the remote terminal transmits a frame (or frames) having a bandwidth less than the bandwidth limit value, the frame flow control apparatus is able to perform frame flow control without discarding a frame (or frames) having a bandwidth that is greater than the bandwidth limit value. In addition, a given frame having bandwidth greater than the bandwidth limit value may be stored in the remote terminal, instead of instead of the frame flow control apparatus. This may be desirable, since the remote terminal has a greater storage capacity than the storage capacity of the frame flow control apparatus.

FIG. 4B is a schematic block diagram showing a structure of a pause frame according to an exemplary embodiment of the present invention. As shown in FIG. 4B, the pause frame may have a standardized format according to an IEEE 802.3X specification. The pause frame structure may include a preamble (PA) field, a start of frame delimiter (SFD) field, a destination address (DA) field, a source address (SA) field, a LENGTH/TYPE field, a media access control (MAC) code field, an Opcode parameters field, a reserved field and a frame check sequence (FCS) field. The reserved field may include first and second control words, as shown in FIG. 4B.

A delay-time identifier may be recorded in the first control word. The delay-time identifier may be a 1-byte word that represents whether or not a delay time is recorded in the second control word. The delay time is recorded in the second control word. For example, the second control word may be two bytes. As discussed above, the frame flow control apparatus may be an Ethernet switch. Since the maximum length of a frame is 1518 bytes in the Ethernet switch, the second control word uses two bytes so as to represent the delay time corresponding to the maximum 1518 bytes of frame.

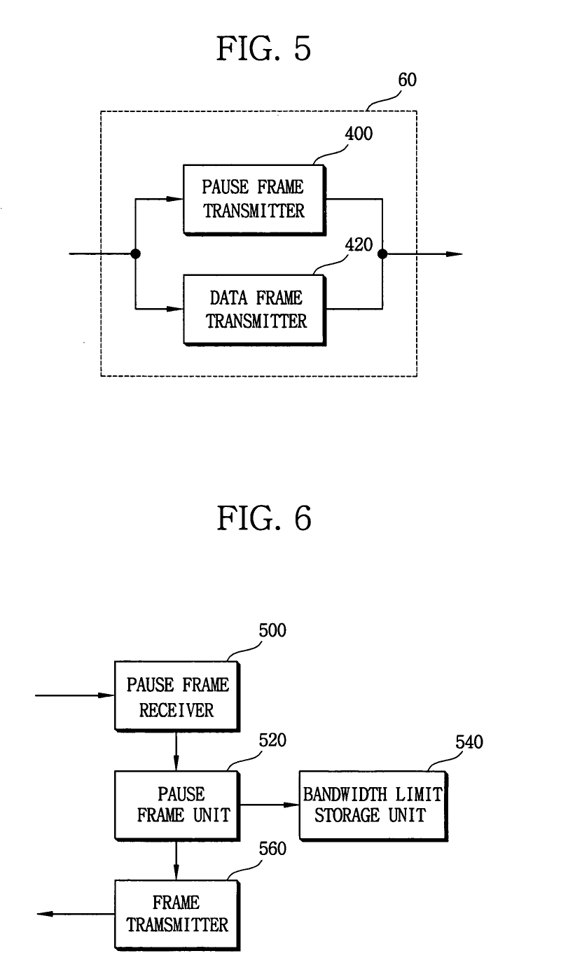

FIG. 5 is a schematic block diagram showing a frame transmitter of FIG. 1 according to an exemplary embodiment of the present invention. As shown in FIG. 5, the frame transmitter 60 may include a pause frame transmitter 400 and a data frame transmitter 420. The pause frame transmitter 400 may be configured to transmit the pause frame generated from the pause frame generator 320 of FIG. 4A to the first port, for example. The data frame transmitter 420 may be configured to transmit the second data frame to the first port.

FIG. 6 is a schematic block diagram showing a frame transmitting apparatus according to another exemplary embodiment of the present invention. As shown in FIG. 6, the frame transmitting apparatus may include a pause frame receiver 500 configured to receive the pause frame from the second port of the frame flow control apparatus, and a pause frame unit 520 configured to calculate the idle time based on the delay time that is recorded in the received pause frame. The frame transmitting apparatus may also include a bandwidth limit storage unit 540 for extracting the bandwidth limit value from the received pause frame, and for storing the extracted bandwidth limit value. Thus, the receiver terminal (i.e. the frame flow control apparatus) and the transmitter terminal (i.e. the frame transmitting apparatus) may share the bandwidth limit information.

The frame transmitting apparatus may include a frame transmitter 560. The frame transmitter 560 may be configured to transmit the first data frame and the pause frame to the second port so that the transmission of the first data frame is delayed by the idle time. The pause frame may represent a pause frame that is transmitted from the second port of the frame flow control apparatus, for example.

The frame transmitting apparatus of FIG. 6 may thus extract the bandwidth limit information from the pause frame received from the second port, and may transmit the first data frame to the second port based on the bandwidth limit information. Thus, the data frame may be more effectively transmitted between the frame flow control apparatus and the frame transmitter 560, as compared with the conventional frame flow control device and frame transmitter.

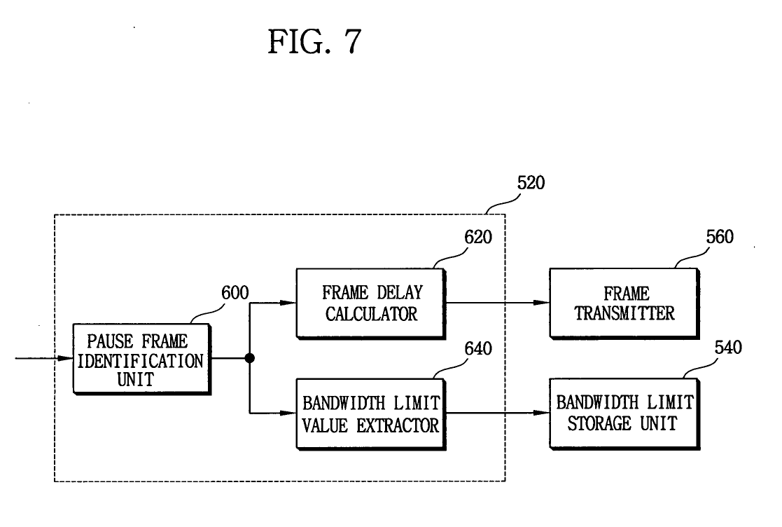

FIG. 7 is a schematic block diagram showing a pause frame unit of FIG. 6 according to another exemplary embodiment of the present invention. As illustrated in FIG. 7, the pause frame unit 520 may include a pause frame identification unit 600. The pause frame identification unit 600 checks whether the frame transmitted from the second port of the frame flow control apparatus is the pause frame having the information indicating the delay time. If the frame transmitted from the second port of the frame flow control apparatus is the pause frame, the frame transmitter 560 transmits the first data frame based on the delay time. If the frame transmitter 560 does not identify the pause frame, the frame transmitter 560 may transmit the first data frame according to a conventional frame flow control algorithm, for example.

The pause frame unit 520 may include a frame delay calculator 620. The frame delay calculator 620 may be configured to calculate the frame delay based on the delay time. The frame delay represents the idle time. For example, when the delay time represents a delay per 64-byte frame and the length of the first data frame is 128 bytes, the idle time corresponds to (2× delay time). The pause frame unit 520 calculates the idle time corresponding to the length of the first data frame using the delay time. Thus, the frame transmitter 560 transmits the first data frame to the second port of the frame flow control apparatus based on the idle time.

The pause frame unit 520 may include a bandwidth limit value extractor 640. The bandwidth limit value extractor 640 may be configured to extract the bandwidth limit value from the pause frame, for example.

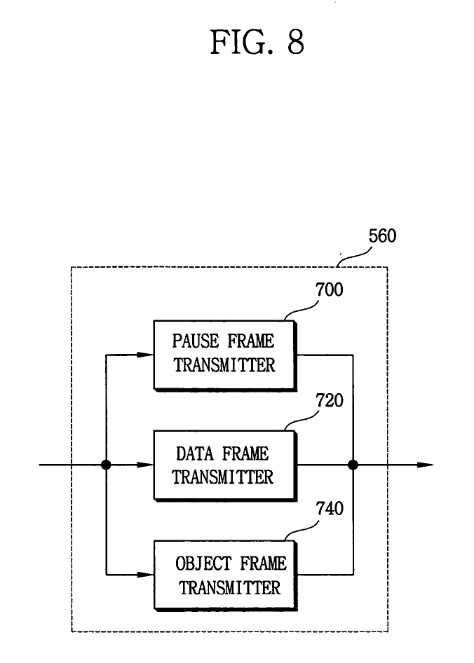

FIG. 8 is a schematic block diagram showing a frame transmitter of FIG. 6 according to another exemplary embodiment of the present invention. As shown in FIG. 8, the frame transmitter 560 may include a pause frame transmitter 700, a data frame transmitter 720 and an object frame transmitter 740.

The pause frame transmitter 700 may be configured to provide the second port of the frame flow control apparatus with the pause frame received from the second port of the frame flow control apparatus. Thus, the frame flow control apparatus may verify that the frame transmitter 560 received the pause frame having the bandwidth limit value. For example, when the frame transmitter 560 receives the pause frame from the frame flow control apparatus, the frame transmitter 560 may send back the same pause frame to the frame flow control apparatus so that the frame flow control apparatus may verify that the frame transmitter 560 received the pause frame.

The data frame transmitter 720 may be configured to provide the second port with a second data frame based on the frame delay. The object frame transmitter 740 may be configured to transmit an object frame having information indicating non-data to the second port. The object frame may be transmitted regardless of the frame delay. When a data frame is transmitted to the second port of the frame flow control apparatus, the object frame may be transmitted to the second port of the frame flow control apparatus without the frame delay (or idle time) after the data frame is transmitted to the second port of the frame flow control apparatus. Namely, the object frame may be transmitted to the second port of the frame flow control apparatus, within the idle time after the data frame is transmitted to the second port of the frame flow control apparatus.

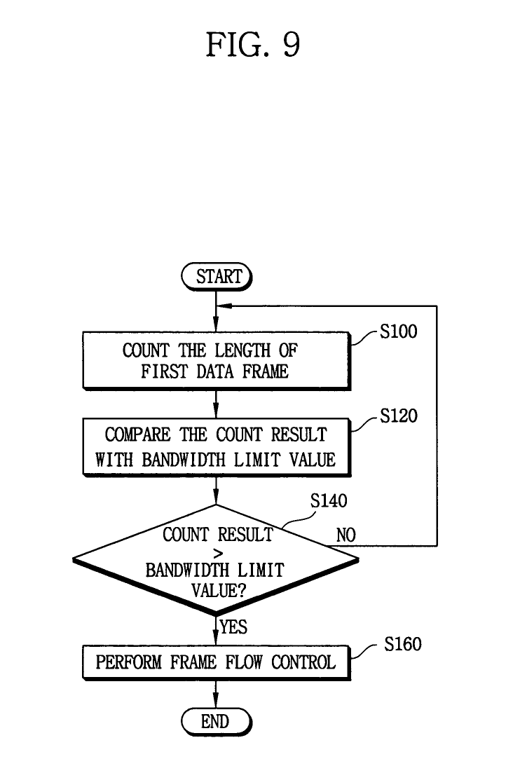

FIG. 9 is a flow chart illustrating a frame flow control method according to an exemplary embodiment of the present invention. Referring to FIG. 9, the length of the first data frame may be counted to obtain a count result (S100). The first data frame may represent a data frame received from the frame transmitter. The count result may be compared with the bandwidth limit value (S120). If the count result of the first data frame is less than the bandwidth limit value (output of S140 is ‘NO’), the procedure returns to S100; otherwise (output of S140 is ‘YES’) the frame flow control is performed (S160), and the pause frame is transmitted to the first port of the frame transmitter.

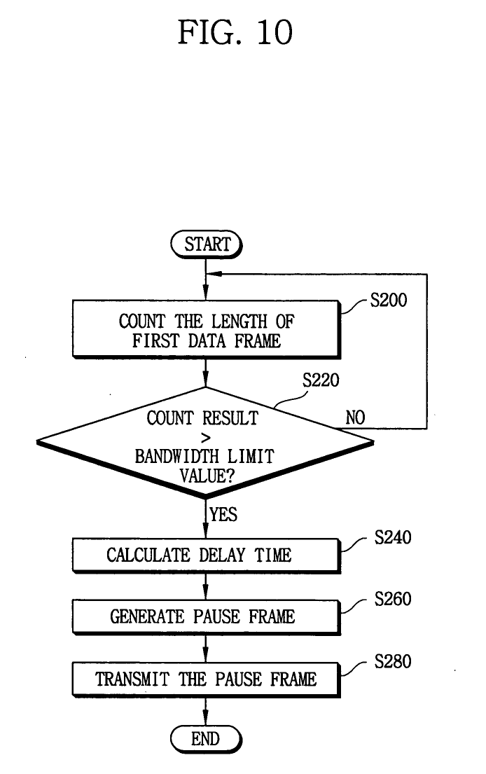

FIG. 10 is a flow chart illustrating a method of transmitting a pause frame according to an exemplary embodiment of the present invention. Referring to FIG. 10, the length of the first data frame may be counted to obtain a count result (S200). and the count result is compared to a given bandwidth limit value (S220). If the count result is less than the bandwidth limit value (output of S220 is ‘NO’), the flow of the procedure returns to S200. If the count result exceeds the bandwidth limit value (output of S220 is ‘YES’), the delay time may be calculated (S240) and the pause frame having the delay time may be generated (S260). The generated pause frame may be provided to the first port (S280).

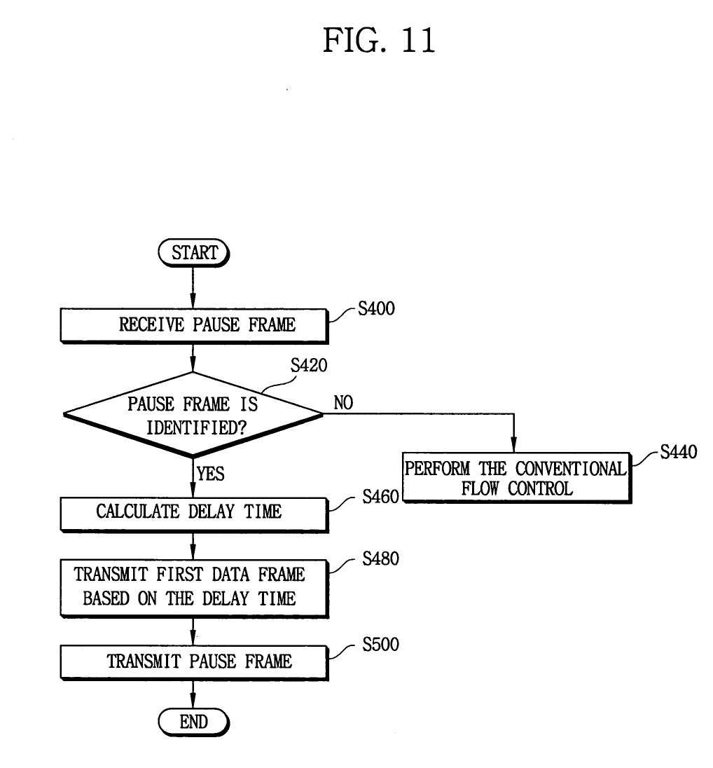

FIG. 11 is a flow chart illustrating a method of transmitting a frame according to one exemplary embodiment of the present invention. Referring to FIG. 11, the pause frame transmitted from the frame flow control apparatus may be received at the frame transmitter (S400). It is checked whether the pause frame is identified by the frame transmitter (S420). For example, when the frame transmitter receives the pause frame from the frame flow control apparatus, the frame transmitter may send back the same pause frame to the frame flow control apparatus, so that the frame flow control apparatus may verify that the frame transmitter has identified (or received) the pause frame.

If the pause frame is not identified by the frame transmitter (output of S420 is ‘NO’), the frame transmitter transmits the first data frame according to the conventional frame flow control algorithm (S440). If the pause frame is identified by the frame transmitter (output of S420 is ‘YES’), the frame delay may be calculated using the delay time (S460), and the frame transmitter may transmit the first data frame to the second port of the frame flow control apparatus based on the frame delay (S480). The pause frame received from the second port of the frame flow control apparatus may be sent back to the second port of the frame flow control apparatus (S500).

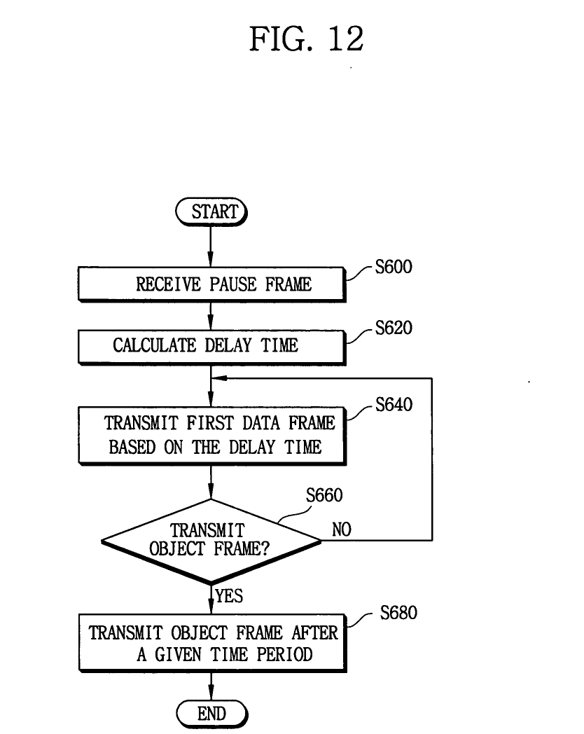

FIG. 12 is a flow chart illustrating a method of transmitting a frame according to another exemplary embodiment of the present invention. Referring to FIG. 12, the pause frame may be received from the second port of the frame flow control apparatus (S600). The frame delay may be calculated based on the delay time included in the pause frame (S620), and the first data frame may be transmitted to the second port of the frame flow control apparatus (S640). It is checked whether an object frame needs to be transmitted to the second port of the frame flow control apparatus (S660). If the object frame does not need to be transmitted (output of S660 is ‘NO’), the flow of the procedure returns to S640, otherwise the object frame is transmitted (output of S660 is ‘YES’) to the second port within the idle time after the first data frame is transmitted (S680) to the second port of the frame flow control apparatus.

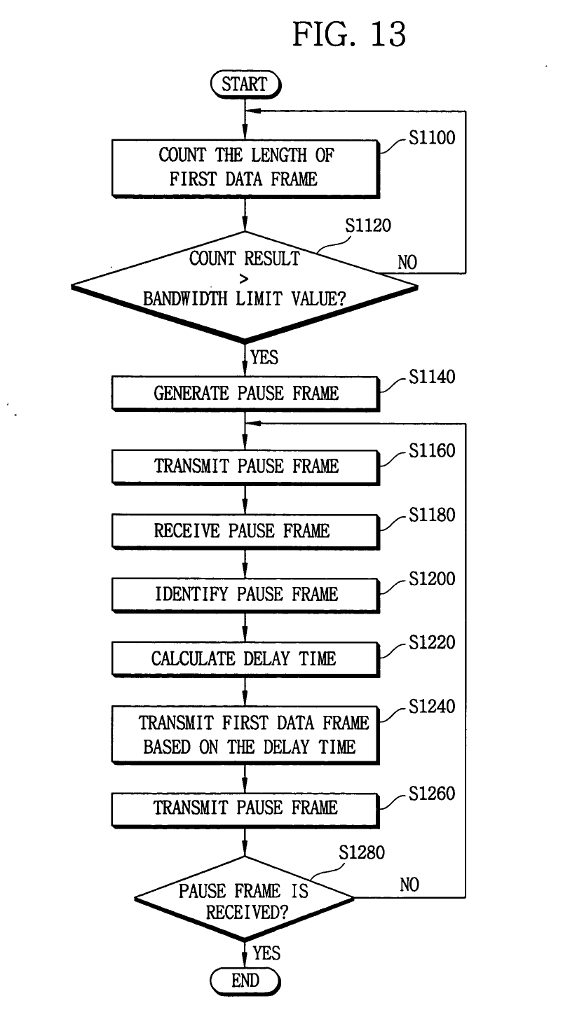

FIG. 13 is a flow chart illustrating a frame flow control method and a method of transmitting a frame according to one exemplary embodiment of the present invention. Referring to FIG. 13, the length of the first data frame may be counted to obtain a count result (S1100). The first data frame may represent a data frame received from the first port of the frame transmitter. The count result is compared to a given bandwidth limit value (S1120). If the count result (first data frame length) is less than the bandwidth limit value (output of S1120 is ‘NO’), the flow of the procedure returns to S1100; otherwise the count result exceeds the bandwidth limit value (output of S1120 is ‘YES’) and the pause frame is generated so as to perform the frame flow control (S1140), and transmitted (S1160) to the first port of the frame transmitter.

The pause frame may be received at the first port of the frame transmitter (S1180), and may be checked whether the pause frame has been identified by the frame transmitter (S1200). For example, when the frame transmitter receives the pause frame from the frame flow control apparatus, the frame transmitter may send back the same pause frame to the frame flow control apparatus, so that the frame flow control apparatus may verify that the frame transmitter has identified (or received) the pause frame.

The frame delay may be calculated based on the delay time included in the pause frame (S1220), and the first data frame may be transmitted to the second port of the frame flow control apparatus (S1240). The pause frame transmitted from the second port may be re-transmitted to the second port of the frame flow control apparatus (S1260), and it may be checked whether the pause frame is received at the second port of the frame flow control apparatus (S1280). If the pause frame is not received at the second port (output of S1280 is ‘NO’), the flow of the procedure returns to S1160, otherwise the pause frame is received at the second port and the frame flow control is terminated.

Although described primarily in terms of hardware above, the exemplary apparatuses and methodologies illustrated in FIGS. 1-4A and 5-13 may also be embodied in software as a computer program. For example, a program in accordance with the exemplary embodiments of the present invention may be a computer program product causing a computer to execute one of the exemplary methods of performing frame flow control or frame transmission. The computer program product may include a computer-readable medium having computer program logic or code portions embodied thereon for enabling a processor of the apparatus to perform the methodology to perform a frame flow control or transmit a frame in accordance with one or more of the exemplary methods.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

The computer program logic may thus cause the processor to perform one or more of the exemplary methods described herein. Therefore, by causing a computer to execute the program, frame flow control and/or frame transmission may be performed effectively in accordance with the exemplary methodologies.

These programs may also be provided in the form of an externally supplied propagated signal and/or a computer data signal embodied in a carrier wave. The computer data signal embodying one or more instructions or functions of the exemplary methodology may be carried on a carrier wave for transmission and/or reception by an entity that executes the instructions or functions of the exemplary methodology. For example, the functions or instructions of the exemplary embodiments may be implemented by processing one or more code segments or instructions of the carrier wave in a computer controlling a given network configuration, where instructions or functions may be executed to perform flow control and/or transmit a frame in accordance with the exemplary methods described herein.

Further, such programs, when recorded on computer-readable storage media, may be readily stored and distributed. The storage medium, as it is read by a computer, may enable the transmission of packets and/or blocks by the exemplary transmission and/or flow control methods described herein.

According to the exemplary embodiments of the present invention, the frame flow control apparatus (for example an Ethernet switch) and the frame transmitter (i.e. remote terminal, for example, a user Personnel Computer (PC)) may share the bandwidth limit information, so that the frame flow control may be performed effectively. In addition, since the idle time may vary depending on the bandwidth limit value, accumulation of data frames at the frame flow control apparatus (for example an Ethernet switch) may be avoided during the frame flow control procedure. Further, since an object frame (or non-data frame) may be transmitted to the remote terminal without waiting for the idle time, the frame flow control may be performed according to the frame type.

The exemplary embodiments of the present invention being thus described, it will be obvious that the same may be varied in many ways. It should also be noted that in some alternate implementations, the functions/acts described in FIGS. 9-13 may occur out of the order noted in the flowcharts. For example, two steps shown in succession may in fact be executed substantially concurrently or the steps may sometimes be executed in the reverse order, depending upon the functionality/acts involved.

Additionally, the functional blocks of FIGS. 1-4A and 5-13 describing the exemplary apparatuses and methods may be implemented in hardware and/or software. The hardware/software implementations may include a combination of processor(s) and article(s) of manufacture. The article(s) of manufacture may further include storage media and executable computer program(s).

The executable computer program(s) may include the instructions to perform the described operations or functions. The computer executable program(s) may also be provided as part of externally supplied propagated signal(s). Such variations are not to be regarded as departure from the spirit and scope of the exemplary embodiments of the present invention, and all such modifications as would be obvious to one skilled in the art are intended to be included within the scope of the following claims.

1. An apparatus for performing a frame flow control, comprising:
a comparator configured to count a length of a first data frame received from a first port, and configured to compare the length to a bandwidth limit value;
a pause frame unit configured to determine a delay time based on the comparison of the comparator, and configured to generate a pause frame with the bandwidth limit value based on the delay time; and
a frame transmitter configured to transmit the pause frame to the first port.

2. The apparatus of claim 1, wherein the pause unit determines the delay time per M-byte frame, M being an integer greater than or equal to 64, if the length of the first data frame exceeds the bandwidth limit value.

3. The apparatus of claim 1, further comprising:
a frame receiver configured to receive the first data frame and the pause frame from the first port.

4. The apparatus of claim 3, wherein the frame receiver includes:
a data frame receiver configured to receive the first data frame from the first port; and
a pause frame receiver configured to receive the pause frame from the first port.

5. The apparatus of claim 1, further comprising:
a bandwidth limiting unit configured to generate the bandwidth limit value; and
a bandwidth limit storage unit configured to store the bandwidth limit value.

6. The apparatus of claim 1, wherein the delay time varies in accordance with the bandwidth limit value.

7. The apparatus of claim 1, wherein the comparator includes:
a frame counter configured to count the length of the first data frame; and
a bandwidth comparator configured to compare the length of the first data frame to the bandwidth limit value.

8. The apparatus of claim 1, wherein the pause frame unit includes:
a delay time calculator configured to calculate the delay time based on the bandwidth limit value; and
a pause frame generator configured to generate the pause frame based on the delay time.

9. The apparatus of claim 1, wherein the frame transmitter includes:
a pause frame transmitter configured to transmit the pause frame to a second port; and
a data frame transmitter configured to transmit a second data frame to the second port.

10. In a frame structure of a pause frame, the pause frame structure having a reserved field, the reserved field comprising:
a first control word in which a delay-time identifier is recorded, the delay-time identifier representing whether or not a delay time is recorded in the pause frame; and
a second control word in which the delay time is recorded.

11. The reserved field on claim 10, wherein the delay time represents a frame delay per M-byte frame when the M-byte frame is transmitted, M being an integer greater than or equal to 64

12. The reserved field of claim 10, wherein the delay time is represented by two bytes.

13. An apparatus for transmitting a frame, comprising:
a pause frame receiver configured to receive a pause frame from a port, the pause frame having a delay time;
a pause frame unit configured to calculate an idle time based on the delay time; and
a frame transmitter configured to transmit a first data frame to the port so that transmission of the first data frame is delayed by the idle time.

14. The apparatus of claim 13, wherein the delay time represents a frame delay per M-byte frame when the M-byte frame is transmitted, M being an integer greater than or equal to 64.

15. The apparatus of claim 13, further comprising:
a bandwidth limit storage unit configured to store a bandwidth limit value.

16. The apparatus of claim 15, wherein the delay time varies in accordance with the bandwidth limit value.

17. The apparatus of claim 13, wherein the pause frame unit includes:
a pause frame identification unit configured to identify the pause frame;
a frame delay calculator configured to calculate the idle time based on the delay time; and
a bandwidth limit value extractor configured to extract a bandwidth limit value from the pause frame.

18. The apparatus of claim 13, wherein the frame transmitter includes:
a pause frame transmitter configured to transmit the pause frame to the port; and
a data frame transmitter configured to transmit a second data frame to the port.

19. The apparatus of claim 18, wherein the frame transmitter further includes an object frame transmitter configured to transmit an object frame having information indicating non-data to the port.

20. The apparatus of claim 19, wherein the object frame transmitter transmits the object frame to the port within the idle time after the first data frame has been transmitted.

21. A method of performing a frame flow control, comprising:
counting a length of a received first data frame;
comparing the length to a bandwidth limit value;
determining a delay time based on the comparison;
generating a pause frame including the bandwidth limit value based on the delay time; and
transmitting the pause frame.

22. The method of claim 21, wherein determining includes determining the delay time per M-byte frame, M being an integer greater than or equal to 64, based on the bandwidth limit value if the length of the first data frame exceeds the bandwidth limit value.

23. The method of claim 21, further comprising:
receiving the first data frame from a port.

24. The method of claim 21, further comprising:
receiving the pause frame from a first port.

25. The method of claim 21, further comprising:
generating the bandwidth limit value; and
storing the bandwidth limit value.

26. The method of claim 21, wherein the delay time varies in accordance with the bandwidth limit value.

27. The method of claim 21, wherein the delay time is represented by two bytes in the pause frame.

28. A method of transmitting a frame, the method comprising:
receiving a pause frame having a delay time;
identifying the pause frame;
determining an idle time based on the delay time; and
transmitting a first data frame to a given port so that transmission of the first data frame is delayed by the idle time; and
transmitting the pause frame to the given port.

29. The method of claim 28, wherein the delay time represents a frame delay per M-byte frame, M being an integer greater than or equal to 64.

30. The method of claim 28, wherein the given port is a port of a frame flow control device.

31. The method of claim 28, further comprising:
storing a bandwidth limit value.

32. The method of claim 31, wherein storing the bandwidth limit value includes:
extracting the bandwidth limit value from the pause frame; and
storing the extracted bandwidth limit value.

33. The method of claim 28, wherein the delay time varies in accordance with the bandwidth limit value.

34. The method of claim 28, further comprising:
transmitting an object frame having information indicating non-data to the given port.

35. The method of claim 34, wherein the object frame is transmitted to the given port within the idle time after the first data frame is transmitted.

36. A computer program product comprising a computer-readable medium having computer program logic stored thereon for enabling a processor to perform a frame flow control, the computer program logic causing the processor to perform the functions of:
counting a length of a received first data frame;
comparing the length to a bandwidth limit value;
determining a delay time based on the comparison;
generating a pause frame including the bandwidth limit value based on the delay time; and
transmitting the pause frame.

37. A computer program product comprising a computer-readable medium having computer program logic stored thereon for enabling a processor to transmit a frame, the computer program logic causing the processor to perform the functions of:
receiving a pause frame having a delay time;
identifying the pause frame;
determining an idle time based on the delay time; and
transmitting a first data frame to a given port so that transmission of the first data frame is delayed by the idle time; and
transmitting the pause frame to the given port.

38. A program, adapted to cause a computer to execute the method of claim 21.

39. A program, adapted to cause a computer to execute the method of claim 28.

40. A computer-readable storage medium, on which is recorded a program adapted to cause a computer to execute the method of claim 21.

41. A computer-readable storage medium, on which is recorded a program adapted to cause a computer to execute the method of claim 28.

42. A computer data signal embodied in a carrier wave, the computer data signal adapted for performing a frame flow control, the computer data signal comprising:
instructions for counting a length of a received first data frame;
instructions for comparing the length to a bandwidth limit value;
instructions for determining a delay time based on the comparison;
instructions for generating a pause frame including the bandwidth limit value based on the delay time; and
instructions for transmitting the pause frame.

43. A computer data signal embodied in a carrier wave, the computer data signal adapted for transmitting a frame, the computer data signal comprising:
instructions for determining whether an output signal of the equalizer converges; and
instructions for receiving a pause frame having a delay time;
instructions for identifying the pause frame;
instructions for determining an idle time based on the delay time; and
instructions for transmitting a first data frame to a given port so that transmission of the first data frame is delayed by the idle time; and
instructions for transmitting the pause frame to the given port.

44. An apparatus for performing a frame flow control in accordance with the method of claim 21.

45. An apparatus for transmitting a frame in accordance with the method of claim 28.
